(19) United States
(12) Patent Application Publication
(10) Pub. No.: US 2025/0082540 A1
(43) Pub. Date: Mar. 13, 2025

(54) MASSAGE APPLICATOR HEAD ASSEMBLY

(71) Applicant: HYPERICE IP SUBCO, LLC, Irvine, CA (US)

(72) Inventors: Robert Glen Edwards, San Diego, CA (US); Trevor Austin Kerth, San Diego, CA (US); Alexander Joseph Aguiar, San Diego, CA (US)

(21) Appl. No.: 18/830,932

(22) Filed: Sep. 11, 2024

Related U.S. Application Data
(60) Provisional application No. 63/582,072, filed on Sep. 12, 2023.
(60) Provisional application No. 63/603,663, filed on Nov. 29, 2023.

(51) Int. Cl. A61H 23/00

(52) U.S. Cl. CPC A61H 23/006; A61H 2201/0107; A61H 2201/0207; A61H 2201/123; A61H 2201/1669

(57) ABSTRACT

A head assembly for a therapeutic massage device includes a battery mounted to a head portion of the head assembly and not installed within the stem portion of the head assembly. The head portion may include a heating element, and the stem portion may include features that allow a tight coupling between the head assembly and a main body of the therapeutic massage device.

### CROSS-REFERENCE TO RELATED APPLICATIONS

This application claims priority to and the benefit of U.S. Provisional Patent Application No. 63/582,072, filed Sep. 12, 2023, and entitled “MASSAGE APPLICATOR HEAD ASSEMBLY,” and U.S. Provisional Patent Application No. 63/603,663, filed Nov. 29, 2023, and entitled “MASSAGE APPLICATOR HEAD ASSEMBLY,” which are incorporated by reference herein in their entireties.

### FIELD

The present disclosure is related to the field of therapeutic devices, and more particularly, to devices that may apply massage to selected portions of a body.

### BACKGROUND

Percussive massage, which is also referred to as tapotement, is the rapid, percussive tapping, slapping, and/or cupping of an area of a human body. Percussive massage may be used to work aggressively and strengthen deep-tissue muscles. Percussive massage can increase local blood circulation and can help tone muscle areas. Percussive massage may be applied by a skilled massage therapist using rapid hand movements. The manual force applied to the body may vary, however, and the massage therapist may tire before completing a sufficient treatment regime.

Percussive massage may also be applied by electromechanical percussive massage devices (percussive massage applicators or massage applicators). Such percussive massage applicators may include, for example, an electric motor coupled to a crank to drive a reciprocating piston within a cylinder. A massage applicator head assembly, that may contact the body and may directly apply pressure thereto, may be an integral part of a percussive massage applicator, or may be removably attached to the piston of the percussive massage applicator.

### SUMMARY

A novel massage applicator head assembly (also referred to as “head assembly”) that can efficiently and effectively provide a therapeutic massage is described herein. The head assembly can not only apply percussive pressure, but also heat, which can increase the effectiveness of the massage. The components that provide heat are selected and configured to increase the efficiency and effectiveness of the head assembly. Thus, in one aspect, a head assembly for a therapeutic device, such as a percussive massage applicator, includes a stem portion that is devoid of a battery pack, and a head portion that includes a flat-profile mounted battery pack. The battery pack has a flat profile along an axis of reciprocating movement of the head assembly.

In some embodiments, the stem portion of the head assembly is solid. The flat-profile mounted battery pack may include a lithium-polymer battery, and/or may have a rectangular top surface. In some embodiments, the head portion includes a top foam layer and a bottom foam layer, where the flat-profile mounted battery pack is disposed between the top and bottom foam layers. The head portion may also include a cover having inner and outer surfaces, and a heating element. The heating element is electrically coupled to the flat-profile mounted battery pack. The heating element defines a bounding box, where the area of the bounding box is smaller than the area of the inner surface of the cover.

In some embodiments, the head portion includes a circuit board that is electrically coupled to the heating element and the flat-profile mounted battery pack. The circuit board controls heating of the heating element. The head portion may include a clamp for holding together the flat-profile mounted battery pack and the circuit board, along with the top and bottom foam layers, when used. The clamp may be configured to hold together only the flat-profile mounted battery pack and the top and bottom foam layer. The head portion may include a cover foam layer disposed between the heating element and the clamp.

In some embodiments, the stem portion includes a first tapering friction ring. The first tapering friction ring has a top side facing the head portion and an opposing bottom side. The first tapering friction ring tapers from the top direction to the bottom direction, such that a first maximum diameter of the first tapering friction ring at the top side thereof is greater than the first smallest diameter of the first tapering friction ring at the bottom side thereof. The diameter of an inner section of the stem portion is smaller than an inner diameter of a receiver portion of the therapeutic device. The receiver portion (e.g., the bore of a piston) is configured to removably receive the stem portion. The first maximum diameter is greater than the inner diameter of the receiver portion.

The stem portion may also include a second tapering friction ring having a top side facing the head portion and an opposing bottom side. The second tapering friction ring also tapers from the top direction to the bottom direction, such that a second maximum diameter of the second tapering friction ring at the top side thereof is greater than a second smallest diameter of the second tapering friction ring at the bottom side thereof. The second maximum diameter may be the same as the first maximum diameter, and/or the second smallest diameter may be the same as the first smallest diameter. In some embodiments, the second maximum diameter is smaller than the first maximum diameter. The thickness of the second tapering friction ring may be the same as a thickness of the first tapering friction ring. In some embodiments, the two tapering friction rings may have different thicknesses. The stem portion may include a fitting ring adapted to match a groove in the receiver portion of the therapeutic device.

In another aspect, a head assembly for a therapeutic device includes a head portion and a stem. The head portion includes a battery pack, and the stem is devoid of any battery pack. The stem is adapted to mate and lock with, via a locking mechanism, a coupler for coupling the head assembly to a body of the therapeutic device. The stem may be solid. The locking mechanism may include one or more tabs, and/or a threading, and/or one or more rings, and/or one or more magnets. In some embodiments, the head assembly includes the coupler, where the coupler is adapted to fit within a piston of the therapeutic device. The coupler may include one or more notches to receive respectively with one or more tabs of the stem, and/or a grooved threading to mate with the threading of the stem, and/or one or more grooves to receive, respectively, one or more rings of the stem, and/or one or more magnets to couple with the one or more respective magnets of the stem.

The battery pack in the head assembly can be a lithium-polymer battery. The head assembly has an axis of reciprocating movement or motion. In some embodiments, the battery pack has an elongated profile along a first battery axis aligned with the axis of reciprocating movement, and a flat profile along a second battery axis normal to the axis of reciprocating movement. In some embodiments, the battery pack has a flat profile along a first battery axis that is aligned with the axis of reciprocating movement.

The head portion of the head assembly may include a cover having inner and outer surfaces. The head portion may also include a heating element that is: (i) electrically coupled to the battery pack, and (ii) disposed between the inner surface of the cover and the battery pack. The heating element may define a bounding box, where the area of the bounding box may be smaller than the area of the inner surface of the cover. The head portion of the head assembly may also include a circuit board or a controller that is electrically coupled to the heating element and the battery pack, for controlling heating of the heating element.

In another aspect, a massage applicator head for a therapeutic device lacks a stem, and includes a battery pack, and a bore. The bore is adapted to receive a head-engagement part of a stem that is attached to a body of the therapeutic device. The head-engagement part of the stem may have a principal locking mechanism, and the bore includes a mating locking mechanism corresponding to the principal locking mechanism.

The principal locking mechanism may include one or more tabs, and/or a threading, and/or one or more rings, and/or one or more magnets. The mating locking mechanism of the bore of the massage applicator head may include one or more notches to receive respectively with one or more tabs of the head-engagement part, and/or a grooved threading to mate with the threading of the head-engagement part, and/or one or more grooves to receive, respectively, one or more rings of the head-engagement part, and/or one or more magnets to couple with the one or more respective magnets of the head-engagement part.

The battery pack in the massage applicator head can be a lithium-polymer battery. The massage applicator head has an axis of reciprocating movement or motion. In some embodiments, the battery pack has an elongated profile along a first battery axis aligned with the axis of reciprocating movement, and a flat profile along a second battery axis normal to the axis of reciprocating movement. In some embodiments, the battery pack has a flat profile along a first battery axis that is aligned with the axis of reciprocating movement.

The massage applicator head may include a cover having inner and outer surfaces. The head portion may also include a heating element that is: (i) electrically coupled to the battery pack, and (ii) disposed between the inner surface of the cover and the battery pack. The heating element may define a bounding box, where the area of the bounding box may be smaller than the area of the inner surface of the cover. The massage applicator head may also include a circuit board or a controller that is electrically coupled to the heating element and the battery pack, for controlling heating of the heating element.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein. Across different figures, the same or similar reference numerals generally indicate the same or similar parts, components, or operations, unless noted otherwise.

FIG. 1 depicts a percussive massage applicator according to various embodiments.

FIGS. 2A and 2B schematically depict two kinds of batteries that may be used in the head assembly of a massage applicator.

FIG. 2C schematically depicts a typical head assembly.

FIG. 3 is an exploded, perspective view of a head assembly according to various embodiments.

FIGS. 4A and 4B are the bottom and side views of a heating element used in a head assembly, according to one embodiment.

FIG. 4C is a zoomed-in, exploded view of a portion of a heating element and additional components.

FIGS. 5A-5D depict different types of heating elements and the corresponding bounding boxes, according to different embodiments.

FIGS. 6A and 6B depict additional types of heating elements.

FIGS. 7A-7C are perspective, side, and cross-sectional views, respectively, of a stem portion of a head assembly, according to one embodiment.

FIG. 7D is a zoomed-in cross-sectional view of a portion of the head assembly of FIGS. 7A-7C.

FIGS. 8A-8C show side and partial cross-sectional views of a head assembly, according to one embodiment.

FIG. 8D shows a perspective view of an embodiment of a battery pack included in the head assembly depicted in FIGS. 8A-8C.

FIGS. 9A-9C show side and partial cross-sectional views of a head assembly, according to another embodiment.

FIG. 9D shows a perspective view of an embodiment of a battery pack included in the head assembly depicted in FIGS. 9A-9C.

FIGS. 10A-10C show side and partial cross-sectional views of a head assembly, according to yet another embodiment.

FIG. 10D shows a perspective view of an embodiment of a battery pack included in the head assembly depicted in FIGS. 10A-10C.

FIGS. 11A-11C show side and partial cross-sectional views of a head assembly, according to one embodiment.

FIG. 11D shows a perspective view of an embodiment of a battery pack included in the head assembly depicted in FIGS. 11A-11C.

FIGS. 12A and 12B show side and partial cross-sectional views of a head assembly, according to one embodiment.

FIG. 12C shows a perspective view of an embodiment of a battery pack included in the head assembly depicted in FIGS. 12A and 12B.

FIGS. 13A and 13B are side and top views of a coupler used with a head assembly and a therapeutic device, according to one embodiment.

FIG. 14 depicts different embodiments of a portion of a stem of a head assembly and the associated locking mechanisms.

FIG. 15 is a side view of another coupler used with a head assembly and a therapeutic device, according to one embodiment.

FIG. 16A schematically depicts a massage applicator of a therapeutic device, according to one embodiment.

FIGS. 16B and 16C are side and partial bottom views, respectively, of a massage applicator head that may be attached to the massage applicator of FIG. 16A, according to one embodiment.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

As used throughout this specification, the words “upper,” “lower,” “longitudinal,” “upward,” “downward,” “proximal,” “distal,” and other similar directional words are used with respect to the views being described.

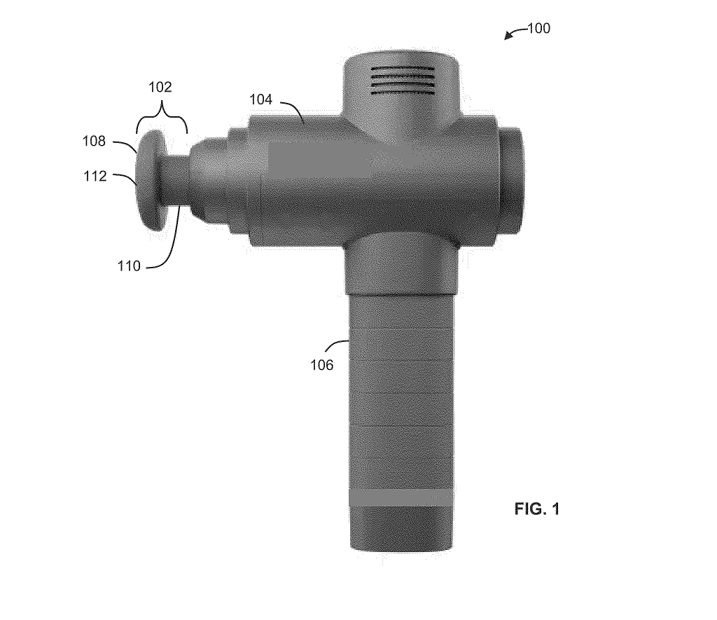

When a head portion of a head assembly (described below with reference to FIG. 1) of a percussive massage applicator (also referred to as a massage device or a device) is applied to a region of the body of a human, the efficacy of the massage therapy provided by the device depends at least in part on the pressure applied to the body. For some persons, a small pressure provides a relaxing massage and a higher pressure may be uncomfortable. For other persons, however, a relatively greater pressure is required to provide relief, e.g., from sore muscles and other sore tissues. For many persons, the pressure needs to be varied from location to location on their bodies.

The efficacy of the massage treatment can be increased further by applying heat to the region of the body under treatment. The heat can be applied before, during, and/or after the percussive massage treatment. Moreover, the heat can be applied continuously, or intermittently. To this end, in some head assemblies used with a massage device, a heating element, such as a heating coil, is provided under the outer surface of the head portion of the head assembly. The operation of the heating element requires a power source and control circuitry.

The power source that enables the percussive motion of the head assembly can also be used to power the heating element. But, the power requirements of a motor producing the percussive motion of the head assembly and those of a heating element can be significantly different. Additionally, the heating element may be operated before or after the application of the percussive massage, and may switched off at least intermittently during the application of the percussive massage. As such in some devices, a power source different from the one used to enable the percussive motion of the head assembly is used, only to power the heating element and the control circuitry thereof. Such a power source can be a battery pack (also referred to as a battery).

FIG. 1 depicts a percussive massage applicator 100 having a head assembly 102, a main body 104, and a handle 106. The head assembly 102 includes a head portion 108 that can contact the region of the body where massage therapy is to be applied, and a stem portion 110 that can be affixed to the main body 104. The head portion 108 and the stem portion 110 can be integral parts of the head assembly 102, or they can be detachable. Likewise, the head assembly 102 can be an integral part of the percussive massage applicator 100, or can be removably attached thereto. Typically, the main body 104 includes a motor, a crank mechanism, and a piston (not shown), where the crank mechanism translates the rotational motion of the motor into a reciprocating motion/movement of the piston. The piston is generally coupled to the stem portion 110, causing the head portion 108 to move back and forth in a reciprocating manner.

A heating element may be provided within the head portion 108, but close to the outside surface 112 of the head portion 108. Typically, a power supply (also referred to as a battery pack or a battery) may be provided in the stem portion (such as the stem portion 110). A common reason for placing the battery in the stem portion is that the shape and size of the stem portion can be readily chosen to accommodate the battery. Generally, the battery is installed within the stem portion in an elongated-profile manner. The terms elongated profile and flat profile depend on the perspective, and as such, as described below within a specific frame of reference.

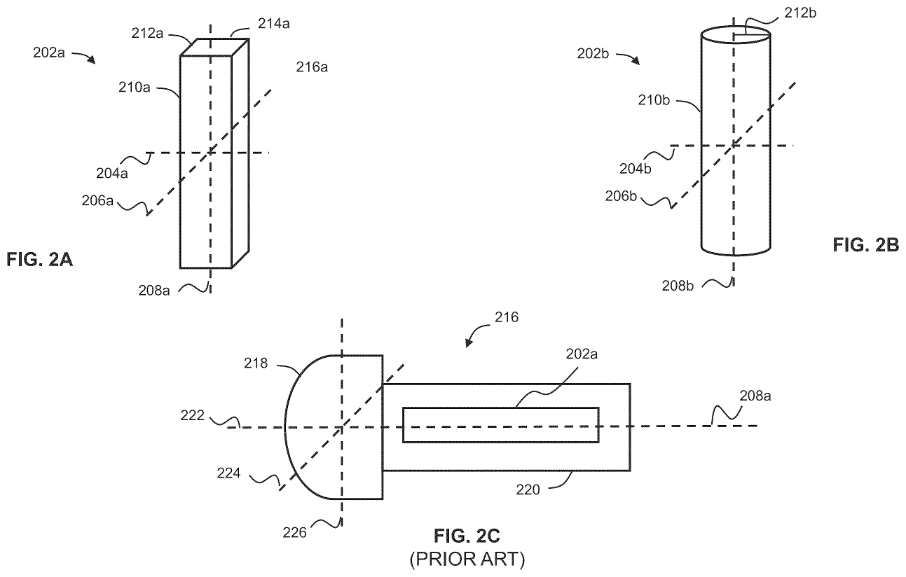

FIG. 2A shows a typical cuboidal battery 202a, with reference to three axes 204a, 206a, 208a. The battery 202a is considered elongated (i.e., having an elongated profile) with reference to the axis 208a. This is because a dimension 210a of the battery 202a along the axis 208a is significantly greater than both of the dimensions 212a, 214a of the battery 202a along the other two axes 204a, 206a, respectively. The dimension 210a may be referred to as thickness or height, and the dimensions 212a, 214a may be referred to as length and width, respectively. As used herein, significantly greater means that the thickness/height along the axis 208a is at least two times the length and width along the axes 204a, 206a.

FIG. 2B shows a typical cylindrical battery 202b, with reference to three axes 204b, 206b, 208b. Like the battery 202a, the battery 202b is also considered elongated (i.e., having an elongated profile) with reference to the axis 208b because a dimension 210b of the battery 202b along the axis 208b is significantly greater than the dimension 212b of the battery 202b along the axes 204b and/or 206b. The dimension 210b may be referred to as thickness or height, and the dimension 212b may be referred to as the radius. Here again, significantly greater means that the thickness/height along the axis 208b is at least two times the radius.

It should be noted that the same battery 202a may be considered a flat battery (or a battery having a flat profile) along the axes 204a and/or 206a. The reason is, the dimensions 212a, 214a of the battery 202a along the axes 204a, 206a, respectively, are not at least two times the dimension 210a of the battery along at least one other axis, i.e., the axis 208a. Likewise, the battery 202b may be considered a flat battery (or a battery having a flat profile) along the axes 204b and/or 206b because the dimension 212b of the battery 202b along the axes 204b, 206b is not at least two times the dimension 210b of the battery along the axis 208b.

FIG. 2C depicts a head assembly 216 having a head portion 218 and a stem portion 220. The axis along which the reciprocating motion of the head assembly 216 can take place is shown at 222. The axis 222 may be referred to as the axis of movement. The other axes of the head assembly are shown at 224, 226. When the battery 202a (or 202b) is installed or mounted within the stem portion 220 such that the axis 208a of the battery 202a (or the axis 208b of the battery 202b) coincides with or is parallel to the axis of movement 222, the battery 202a (or 202b) is considered an elongated-profile installed or elongated-profile mounted battery. Such an installation is generally necessary because the battery 202a (or 202b) often cannot fit within the head portion 218, and also because the stem portion 220 is usually shaped such that the battery 202a (or 202b) can fit only when the axis 208a (or 208b) coincides with or is parallel to the axis of movement 222.

One benefit of such an installation is that the stem portion 220 can be narrow, i.e., the dimensions of the stem portion 220 along the axes 224 and/or 226 need not be as large as the dimension of the battery 202a (or 202b) along the axis 208a (or 208b). Thus, the reciprocating motion of the head assembly 216 can be smooth because the mass of the battery 202a (or 202b) and the mass of the stem portion 220 are distributed relatively close to the axis of movement 222, than when the stem portion 220 is wider, e.g., having a dimension along the axis 224 or 226 as large as the dimension of the battery 202a (or 202b) along the axis 208a (or 208b).

While the above described configuration may have the benefit of smooth reciprocating motion due to a distribution of mass close to the axis of movement, such a configuration generally requires a relatively long, hollow stem, to contain a battery. In some cases, a solid, relatively shorter stem can be more efficient and/or effective in applying percussive massage to the body. A massage applicator having a relatively shorter stem can also be ergonomic and may be easier to operate to a user than an applicator having a relatively longer stem.

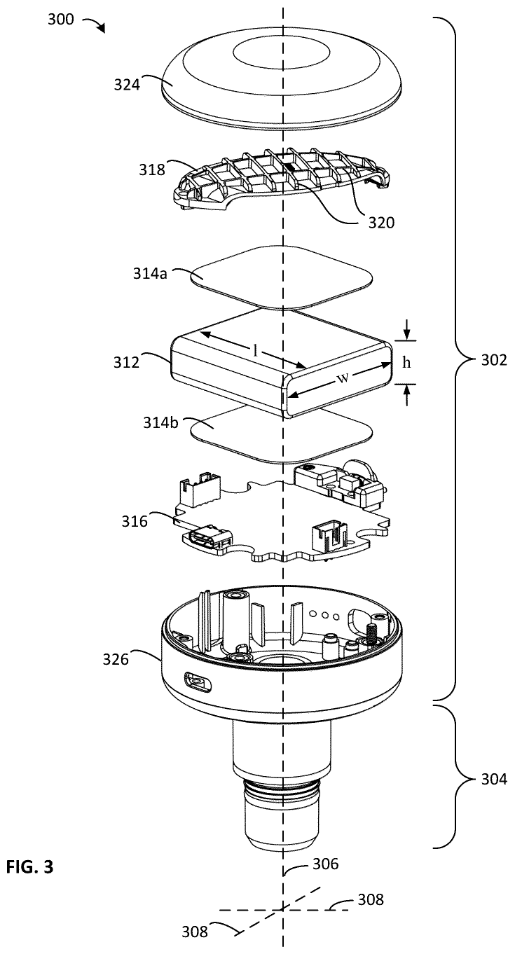

Accordingly, FIG. 3 depicts an exploded view of a head assembly 300, where a battery can be installed or mounted within a head portion of the head assembly. The head assembly 300 includes a head portion 302 and a stem portion 304. The axis of reciprocating movement of the head assembly, also referred to as the axis of movement, is shown at 306. The other two axes are shown at 308, 310. A battery 312 is installed or mounted within the head portion 302 such that the battery 312 has a flat profile with respect to the axis of movement 306. In other words, the length (1) and width (w) of the battery 312 are significantly larger than (e.g., at least two times) the height/thickness (h) of the battery 312.

The surfaces of the battery 312 that are normal to the axis of movement 306 are generally rectangular. These surfaces may be referred to as the top and bottom surfaces, and in different embodiments, these surfaces can have different shapes, e.g., circular, polygonal other than rectangular, etc. Regardless of the shape of the top and bottom surfaces, however, the battery 312 has a flat profile with respect to the axis of movement 306. In general, a battery having a flat profile with respect to one of its axes may be referred to as a low profile battery. Compared to lithium-ion batteries, lithium-polymer batteries often have a lower profile. As such, in some embodiments, the battery 312 is a lithium-polymer battery. A lithium-polymer battery may provide additional benefits over a lithium-ion battery such as it is less likely to combust due to overheating, and is less likely to leak the battery electrolyte, compared to a lithium-ion battery. In some embodiments, however, the battery 312 is a lithium-ion battery because it may offer greater energy density, and can thus last longer before a recharge, compared to a lithium-polymer battery.

In order to protect the battery 312 from the vibrations resulting from the percussive, reciprocating movement of the head assembly 300, and/or the heat from a heating element (discussed below) the battery may be encased within a top foam layer 314a and a bottom foam layer 314b. The battery 312 (with or without the foam layer(s)) is disposed over a circuit board 316. The circuit board includes circuitry to control the heating of a heating element (described below) and one or more connectors to receive input signals from a user interface (not shown), and to provide power to the heating element. The control circuitry may include custom circuitry implemented using discrete components, FPGAs, ASICs, general-purpose processor(s), and/or memory to store a program or instructions to be executed by the processor. The user interface may be attached to the percussive massage applicator, and may be used to control the operation of heating of the element. The parameters of heating that may be controlled by a user include, but are not limited to, the peak temperature, whether the heat is applied before, during, and/or after the percussive massage, whether the heating is continuous or intermittent, and the on and off durations, if intermittent.

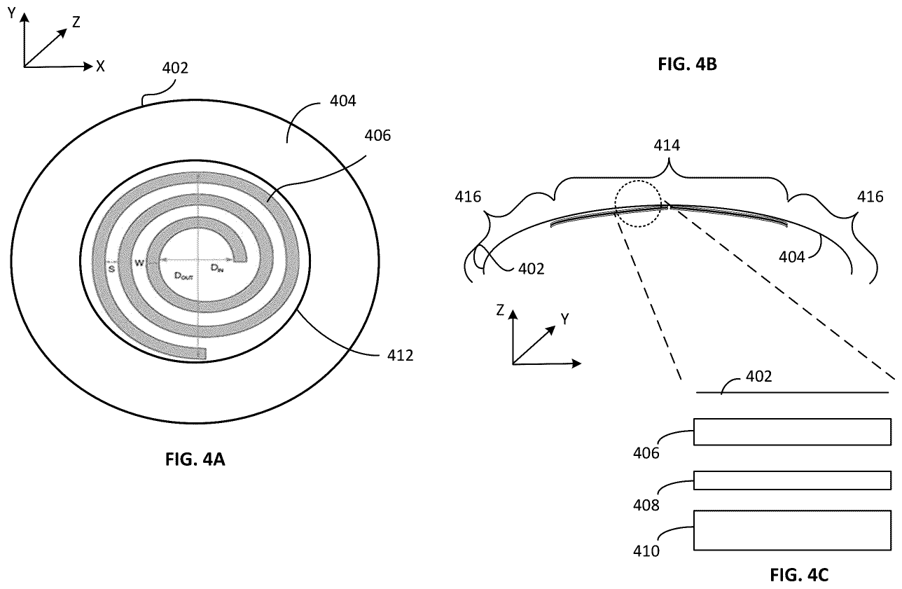

In some embodiments, a clamp 318 is provided to secure the battery 312, and the foam layers 314a, 314b (if used), to the circuit board 316. The clamp 318 can help keep the wires from the connectors of the circuit board 316 away from battery 312. The claim 318 can also help directing different sets of wires to different sections of the heating element, without getting entangled. The clamp 318 may be shaped like a surfboard, and may have rims 320 over its top surface. The rims 320 can support a cover foam layer (shown in FIG. 4) that may be disposed over the clamp 318.

The head portion 302 includes a cover 324 and a base portion 326. The base portion 326 can be attached to the stem portion 304, or the stem portion 304 may extend from and can be an integral part of the base portion 326. The circuit board 316 may be removably affixed to the base portion 326, e.g., using screws, clamps, or other fastening mechanisms. When the percussive massage applicator is in use, the outer surface of the cover 324 may contact the region of the body to be treated. Since the user may wish to apply heat to the body, the cover 324 is generally made using a heat-conductive material, such as a metal or an alloy, or another material containing a metal or an alloy. In various embodiments, a heating element (shown in FIGS. 4A-4C) is disposed on the inner surface of the cover 324. The heating element is electrically coupled to the circuit board 316, e.g., using wires.

FIGS. 4A and 4B depict a bottom view and a corresponding side view of a cover 402 of a head portion of a head assembly. The cover 402 has an inner surface 404. A heating element 406 is mounted to the inner surface 404. In different embodiments, the heating element 406 may be completely in physical contact with the inner surface 404 or may only partially physically contact the inner surface 404. The heating element 406 may also be disposed close to (e.g., at a distance that is only a fraction of an inch), but without physically contracting the inner surface 404. The inner and outer surface(s) of a heating element can be planar and/or curved. In some embodiments, the curvature of the outer surface of the heating element 406 matches the curvature of the inner surface 404 of the cover 402. In some embodiments, the outer surface of the heating element 406 may have a different curvature from that of the inner surface 404 of the cover 402.

FIG. 4C is an exploded close up of a small portion of the structure shown in FIG. 4B. For simplicity, various components are depicted as having flat surfaces, though these surfaces may be curved, as shown in FIGS. 4A and 4B. FIG. 4C shows that the heating element 406 is placed on an optional cover foam layer 408, and the cover foam layer 408 is placed on a clamp 410, e.g., the clamp 318 in FIG. 3.

In various embodiments, a heating element does not span the entire inner surface of the cover. Rather, the heating element spans only a portion of the inner surface. This is illustrated referring back to FIG. 4A. The heating element 406 has a bounding box 412. As used herein, a bounding box is a region of a selected shape, e.g., square, rectangle, another polygon, circle, oval, etc., in a selected plane. Moreover, for the selected shape, the bounding box is the smallest region that encloses a planar projection of the heating element in the plane of the bounding box. For example, the planar projection in the X-Y plane of the heating element 406 is a spiral (also shown at 406). The smallest oval-shaped region that encloses the spiral defined by the heating element 406 is shown at 412, and is designated as the bounding box 412 of the heating element 406.

The projection in the X-Y plane of the inner surface 404 of the cover 402 is an oval, also shown at 402. The area of the bounding box 412 is less than the area of the projection of the cover 402. Therefore, the heating element 406 is considered not to span the entire inner surface 404 of the cover 402. In various embodiments, the area of the bounding box of a heating element mounted to the inner surface of a cover of a head assembly is less than 80%, 75%, 70%, 60%, etc., the area of the projection of the inner surface of the cover in the plane of the bounding box. Typically, a heating element is mounted centrally to the inner surface of the cover. This allows for a symmetrical distribution of heat throughout the cover 402. In some embodiments, however, a heating element may be mounted to the inner surface 404 in an eccentric or off-center manner. In some embodiments, a heating element may span substantially the entire surface (e.g., more than 80%, 90%, 95%, etc.) of the inner surface 404 of the cover 402.

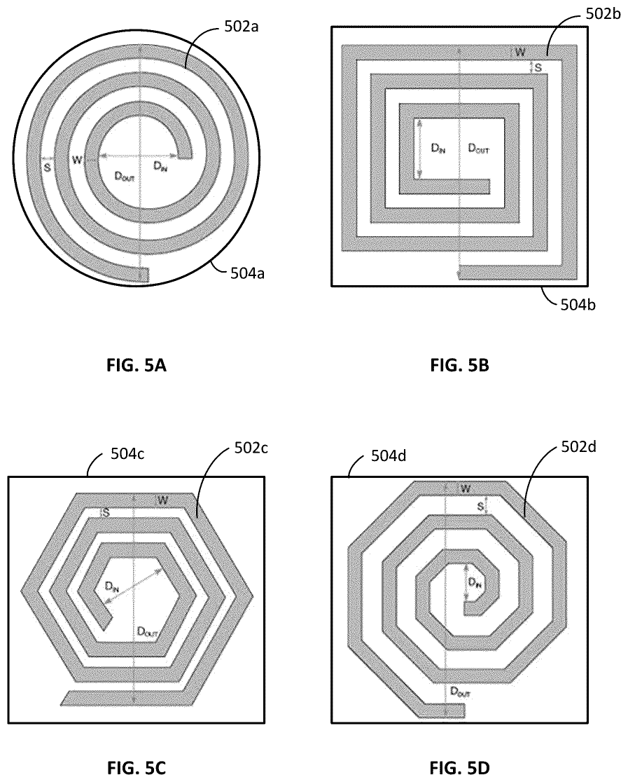

The shape of a bounding box can be the same as that of the cover projection, but a bounding box can also have a different shape from that of the cover projection. For example, as shown in FIGS. 5A and 5B, the heating elements 502a, 502b are circular and square spirals, respectively. Correspondingly, the bounding boxes 504a, 504b are a circle and a square respectively. The shape of a bounding box need not, however, match the shape of the corresponding heating element. For example, as shown in FIGS. 5C and 5D, the heating elements 502c, 502d are hexagonal and octagonal spirals, respectively, but the bounding boxes 504c, 504d are both squares.

Referring to FIGS. 4A and 5A-5D, any one of the heating elements 502a-d can be mounted to the inner surface 404 of the cover 402, replacing the heating element 406. The inner surface 404 has an oval-shaped projection in the X-Y plane. Thus, the shape of the respective bounding boxes 504a-d would be different from the shape of the projection of the cover 402. Any of the heating elements 502a-d can be considered as not spanning the entire inner surface 404 of the cover 402, if the respective areas of the respective bounding boxes 504a-d are smaller than the area of the projection of the cover 402.

A heating element that does not span the entire inner surface of the cover to which the heating element is mounted is generally smaller than a heating element that spans substantially the entire inner surface of that cover. Thus, with respect to a particular cover, the heating element that does not span the entire inner surface of the cover may be referred to as a smaller heating element and the one that does span substantially the entire inner surface of the cover may be referred to as a full-size heating element. The power needed to heat a smaller heating element to a particular temperature during a certain time duration is generally less than that required to heat a full-size heating element to the same temperature, within the same time duration. Accordingly, a head assembly can be designed to be effective and/or efficient, as follows.

Referring to FIGS. 4A and 4B, the heating element 406 is a smaller heating element with respect to the cover 402, compared to a corresponding full-size heating element (not shown). Therefore, a relatively smaller battery (e.g., the battery 312 in FIG. 3), may be sufficient to heat the heating element 406 to a specified temperature within a specified time duration, than that would be necessary to heat a corresponding full-size heating element to the same temperature within the same time duration. A particular battery used to heat the smaller heating element may also last longer before a recharge compared to using the same battery to heat the corresponding full-size heating element. Moreover, a particular battery may heat the smaller heating element to a target temperature faster compared to the time duration required to heat the corresponding full-size heating element to the same temperature using the same battery. Alternatively, within a specified time duration, a particular battery may heat the smaller heating element to a higher temperature compared to the temperature attainable for the corresponding full-size heating element. These relationships can be used to determine various heating related parameters such as the battery size and/or capacity, peak output power (power rating) of the battery, maximum attainable temperature of the heating element, and/or the time duration required to attain a maximum or a specified temperature.

As seen in FIGS. 4A and 4B, the heating element 406 is mounted centrally to the inner surface 404 of the cover 402. As noted above, this is a typical configuration, but not a necessary one. Because the heating element 406 is a smaller one, and not a full-size one, when the heating element 406 is heated, a central region 414 of the cover 402 may heat up before the off-center region 416. Eventually, the off-center region 416 would also heat up because the cover 402 is heat conductive. The lag between the heating up of the regions 414 and 416 can range from a few seconds to tens of seconds. Using a full-size heating element instead of the smaller heating element 406 may result in one or more of the following. A larger battery may be needed; the maximum attainable temperature of the full-size heating element may be lower; and/or it may take longer to heat the full-size heating element to heat it to the maximum or a specified temperature. In contrast, as the full-size heating element would heat up, substantially all of the cover 402 would also heat up without any noticeable time differences in the heating of different portions of the cover 402.

From a user's perspective, when using the smaller heating element 406, the relatively faster heating of the central region 414 can immediately provide some relief or therapeutic heat treatment to the portion of the body in physical contact with the central region 414 of the cover 402. Within a short time, e.g., in less than one or two minutes after the central region 414 is heated up, the rest of the cover 402 would also heat up, providing relief or therapeutic heat treatment to the portion of the body in physical contact with substantially the entire outer surface of the cover 402.

In exchange for such staged heating effect, the following benefits for the overall massage applicator (or its head assembly) can be achieved, however, compared to using a full-size heating element. A smaller battery may be sufficient; the maximum attainable temperature can be higher; and/or it may take a shorter time duration to heat at least the central region 414 to the maximum or a specified temperature. Thus, for a particular cover, compared to using a corresponding full-size heating element, using a smaller size heating element can be more effective, e.g., in terms of faster and/or greater heating of the central region of the cover; more efficient, e.g., by requiring a smaller battery, or by extending the battery life between successive charging thereof; or both effective and efficient.

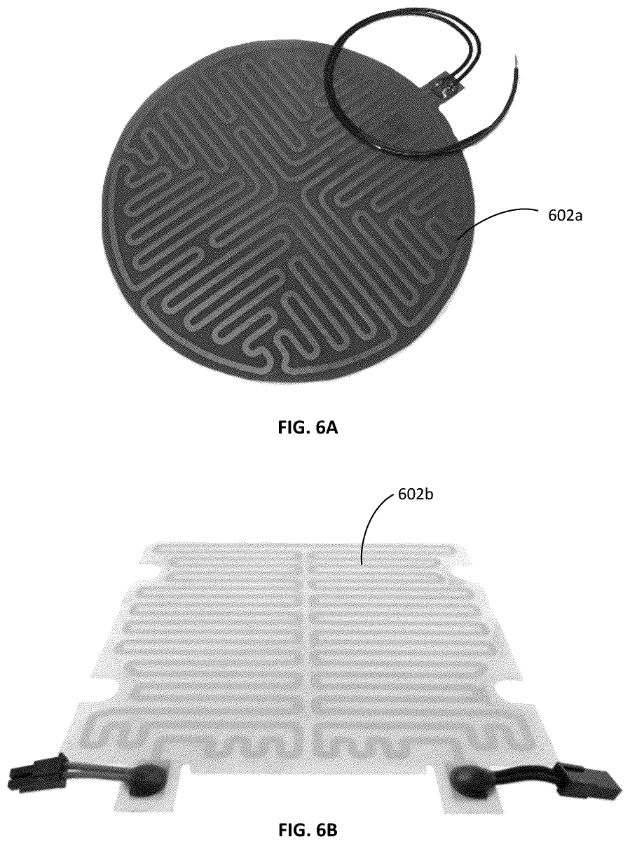

While FIGS. 4A and 5A-D depict spiral-type heating elements, other types of heating elements can also be used in different embodiments. For example, FIGS. 6A and 6B depict circular and rectangular hearing elements 602a, 602b, respectively. These heating elements have non-regular, e.g., zig-zag patterns. A heating element may also include sections that can be individually controlled, e.g., turned on or off at different times and/or may be set to attain different temperatures.

Referring back to FIG. 1, in various embodiments, the head assembly 102 is removably attached to a piston (not shown) located within the main body 104 of the percussive massage applicator 100. The reciprocating movement of the piston is facilitated by a motor-crank mechanism (not shown) disposed within the main body 104, and the reciprocating motion of the piston results in a reciprocating motion of the head assembly 102. Head assemblies that are removably attached to the piston allow a use to use different kinds of head assemblies per the user's needs. For example, a user may switch between head assemblies having or not having a heating element, depending on whether heat therapy is desired or not desired. A user may also select from different head assemblies having different head portions having different shapes and/or surface areas, depending on the part of the body to which massage is to be applied. For example, a head portion can be bullet shaped, spherical, disc shaped, Y shaped, etc.

To facilitate the use of different types of head assemblies, the head assembly 102 should be easily detachable from and attachable to the piston within the main body 104. Once attached to the piston, however, the head assembly 102 should remain attached to the piston, and not come loose unintentionally, e.g., due to the percussive motion of the piston. In order to achieve these two objectives, namely, convenient attachment and detachment of a head assembly to the piston, and maintaining coupling between the head assembly and the piston during use and until the head assembly is intentionally detached, in various embodiments certain features are provided on the stem portion 110 of the head assembly 102.

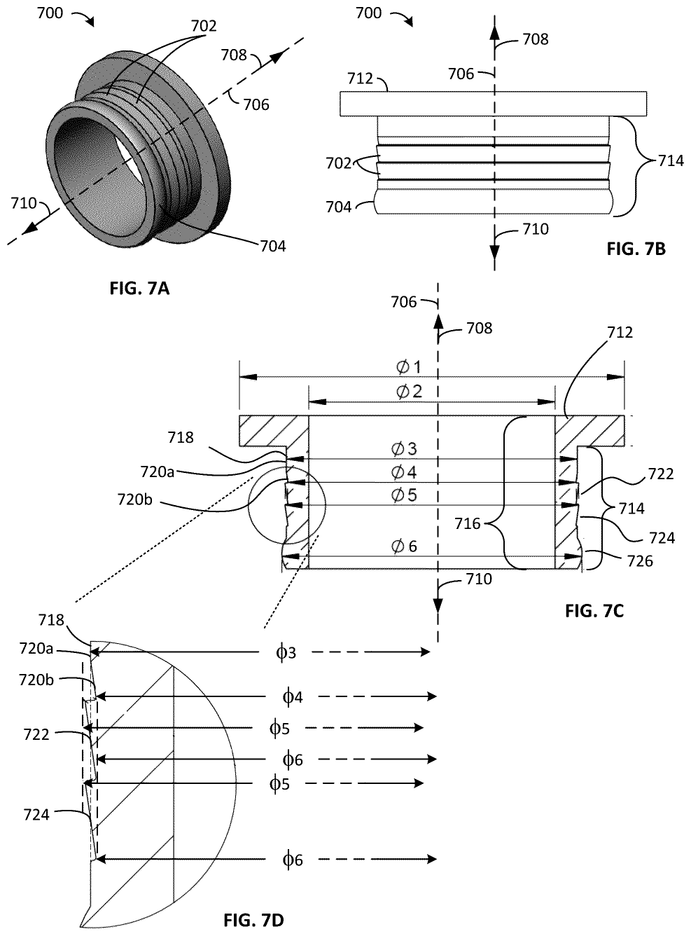

In particular, referring to FIG. 7A, a stem portion 700 of a head assembly (not shown), e.g., the stem portion 110 of FIG. 1 or the stem portion 304 of FIG. 3, includes one or more friction rings 702 and an optional fitting ring 704. As described below, these features can facilitate easy attachment/detachment of the stem portion 700 to the piston of the massage applicator (not shown), but also a firm attachment to the piston, when detachment is not intended. The axis of reciprocating movement of the head assembly is shown at 706. In the reciprocating movement of the head assembly, the direction of movement away from the main body (not shown) of the massage applicator is shown at 708, and the direction of movement towards the main body is shown at 710.

Referring to FIG. 7B, which is a side view of the stem portion 700 of FIG. 7A, the stem portion 700 has a top section 712 over which the head portion (not shown) of the head assembly is located. The stem portion 700 also has a coupling section 714, that couples with the piston of the massage applicator. Although the stem portion 700 is hollow, in various embodiments, sections of the stem portion or the entire stem portion can be solid. While this can increase the mass of the head assembly, and thus the power needed to move the head assembly, a solid stem portion can more effectively and/or efficiently transfer the forces from the reciprocating piston to the head assembly, and then to the region of the body to be massaged.

FIG. 7C, which is a cross-sectional view of the stem portion 700, illustrates the diameters associated with the features friction rings 702 and the fitting ring 704, and certain other diameters. The top section 712 has a diameter ϕ1, and an inner section 716 has a diameter ¢2. The inner section 716 spans both the top section 712 and the coupling section 714. In the stem portion 700, the diameter ϕ1 is greater than the diameter ϕ2, but this is not necessary. An advantage of a top section 712 having a diameter greater than that of the inner section 716 is described below.

In the discussion below, the directions “top,” “upper,” and “above” generally refer to the direction of movement of the head assembly away from the massage applicator body, i.e., the direction 708. Conversely, the directions “bottom,” “lower,” and “below” generally refer to the direction of movement of the head assembly towards the massage applicator body, i.e., the direction 710. A two-part friction ring 718 surrounds the inner section 716 at a location below the top section 712. The friction ring 718 has a non-tapering part 720a and a tapering part 720b below the non-tapering part 720a. The diameter of the non-tapering part 720a is ϕ3, and the smallest diameter of the tapering part 720b is ϕ4. Both ϕ3 and ϕ4 are greater than the diameter of the inner section ϕ2, and ϕ3 is greater than ϕ4. In some embodiments, a non-tapering friction ring having a diameter ϕ3 may replace the two-part friction ring 718, and a tapering friction ring having top (maximum) and bottom (smallest) diameters ϕ3 and ϕ4, respectively, may be installed below the non-tapering friction ring.

Two additional friction rings 722, 724 surround the inner section 716. The friction ring 722 is disposed at a location below the tapering part 720b of the friction ring 718, and the friction ring 724 is disposed below the friction ring 722. In the stem portion 700, the friction rings 722, 724 are similar, but this is not necessary. In other embodiments, different friction rings can have different dimensions, e.g., diameters and/or heights (also referred to as thicknesses). Each of the friction rings 722, 724 tapers from top to bottom. Thus, the friction rings 722, 724 each has a top diameter ϕ5, and a smaller, bottom diameter ϕ6. In the stem portion 700, ϕ6 is the same as ϕ4, but in some embodiments, ϕ6 can be different from, i.e., less than or greater than, ϕ4, but ϕ5 is greater than ϕ6. The top diameter ϕ5 of the friction ring 722 is typically, though not necessarily, greater than the diameter ϕ3 of the non-tapering part 720a of the friction ring 718. A stem portion typically includes two tapering friction rings 722, 724, but in some embodiments a stem portion may include only one tapering friction ring or may include more than two, e.g., 3, 5, etc., tapering friction rings.

The stem portion 700 also includes an optional fitting ring 726, which is not tapered. Typically, though not necessarily, the diameter ϕ7 of the fitting ring 726 is greater than the largest of the diameters ϕ3 and ϕ5. The fitting ring is designed to fit within a groove provided in a bore (not shown) of the piston of the massage applicator, where the stem portion 700 is received in the bore. As seen in FIGS. 7C and 7D, the design of friction rings 718, 722, and 724, specifically the tapering part 720b of the friction ring 718 and the tapering shape of the friction rings 722, 725 form a barbed outer surface of the coupling section 714. This barbed surface allows for a relatively easy insertion of the stem portion 700 into the bore of the piston, but provides a resistance to unintentional detachment of the stem portion 700 (and thus the head assembly) from the piston, as described below.

The stem portion 700 is to be received within the bore (not shown) of the piston of the massage applicator. The diameter ϕ2 of the inner section 716 may be smaller than the inner diameter of the bore of the piston, but the smallest diameter ϕ4 of the tapering part 720b of the friction ring 718 may be chosen to be the same as the inner diameter of the bore of the piston. In some embodiments, the diameter ϕ4 can be larger or smaller than the inner diameter of the bore, e.g., larger or smaller by 0.5%, 1%, 2%, 5%, etc. Thus, when the stem portion 700 is inserted into the bore, i.e., forced in the direction 710, for each friction ring, the portion thereof that first comes into contact with the inner surface of the bore may have a dimeter that is smaller than or about the same as the diameter of the bore. This can make the insertion of the head assembly into the bore of the piston relatively easy. In contrast, should the stem portion 700 move in the opposite direction, i.e., away from the body of the massage applicator (i.e., in direction 708), the contact between the relatively wider portions of the friction rings, where the diameters ϕ3 and ϕ5 may be greater than the diameter of the bore of the piston, can provide substantial frictional resistance. As such, unintentional movement and detachment of the stem portion 700 from the piston can be prevented, even when the massage applicator is in use and the head assembly is moving back-and-forth.

Table 1 below lists the values of various diameters discussed above, and Table 2 lists the values of thicknesses of different parts/components of the stem portion 700. Table 3 lists the ranges of various diameters in proportion to the inner diameter of the bore of the piston. It should be understood that these values and ranges are provided as examples only. Different embodiments may have other values as long as the relative order of the diameters, as described above, is maintained. Table 3 lists ranges of diameter proportions for different embodiments of the stem portion 700. These ranges are typical, but do not necessarily specify the maximum and/or minimum values for the respective diameter proportions. For example, ϕ1 can be greater by more than 40%, or greater by less than 30%, of the inner diameter of the bore of the piston. Every value within the respective range provided for each parameter in Table 3, is contemplated and expressly supported herein, subject to the number of significant digits expressed in each particular range.

TABLE 1
Example Diameters of Parts of Stem Portion

| Diameter | Symbol | Value (mm) |
|---|---|---|
| Diameter of Top Section of Stem | ϕ1 | 25.00 |
| Diameter of Inner Section | ϕ2 | 16.00 |
| Diameter of Non-Tapering Part of Two- | ϕ3 | 18.90 |
| Part Friction Ring | | |
| Smallest Diameter of Tapering Part of | ϕ4 | 18.72 |
| Two-Part Friction Ring | | |
| Top (Maximum) Diameter of Tapering | ϕ5 | 19.08 |
| Friction Ring | | |
| Bottom (Smallest) Diameter of | ϕ6 | 18.72 |
| Tapering Friction Ring | | |
| Diameter of Fitting Ring | ϕ7 | 19.50 |

TABLE 2
Example Thicknesses of Parts of Stem Portion

| Part | Value (mm) |
|---|---|
| Top Section of Stem | 2 |
| Inner Section | 10 |
| Tapering Friction Ring | 1.4 |
| Fitting Ring | 2 |

TABLE 3
Diameters of Parts of Stem Portion Relative
to Inner Diameter of Piston Bore

| | | Larger (except |
|---|---|---|
| | | ϕ2) than Inner |
| | | Diameter of |
| Diameter | Symbol | Piston Bore by |
| Diameter of Top Section of Stem | ϕ1 | 30-40% |
| Diameter of Inner Section | ϕ2 | 10-15% smaller |
| Diameter of Non-Tapering Part of Two- | ϕ3 | 2-5% |
| Part Friction Ring | | |
| Smallest Diameter of Tapering Part of | ϕ4 | 1-4% |
| Two-Part Friction Ring | | |
| Top (Maximum) Diameter of Tapering | ϕ5 | 3-7% |
| Friction Ring | | |
| Bottom (Smallest) Diameter of | ϕ6 | 1-4% |
| Tapering Friction Ring | | |
| Diameter of Fitting Ring | ϕ7 | 5-8% |

As noted above, having a top section that has a larger diameter than that of the inner section, (such as the top section 712 and the inner section 716 of the stem portion 700), can be beneficial. In such embodiments, the top section 712 can serve as a stop when the stem portion 700 is inserted into the bore of the piston. This may allow a proper engagement of the stem portion 700 and the head assembly with the piston, so that the reciprocating motion of the piston is translated effectively into a reciprocating motion of the head assembly. In doing so, it can also be ensured that the stem portion 700 is not pushed too far into the bore of the piston, so as to damage the piston.

In various embodiments, the bore of the piston and the inner section of the stem can be metallic or made from other hard materials. The friction rings 718, 722, 724, and the fitting ring 726 can be made using a hard but flexible material, such as hard rubber, so that the stem portion 700 can be inserted into and removed from the bore of the piston. Also, although the cross-section of stem portion 700, the friction rings 718, 722, 724, and the fitting ring 726 are circular, this is not essential. In different embodiments, the cross-section of the stem portion and the corresponding friction and fitting rings can have different shapes, such as square, rectangle, hexagon, another polygon, oval, etc. Accordingly, instead of (or in addition to) the diameters of the inner section of the stem portion, the bore of the piston, the friction rings, and/or the fitting ring, other applicable dimensions, such as the length/width and/or the distance between two opposing vertices/sides of a polygon, may be selected to provide a barbed surface for the stem portion.

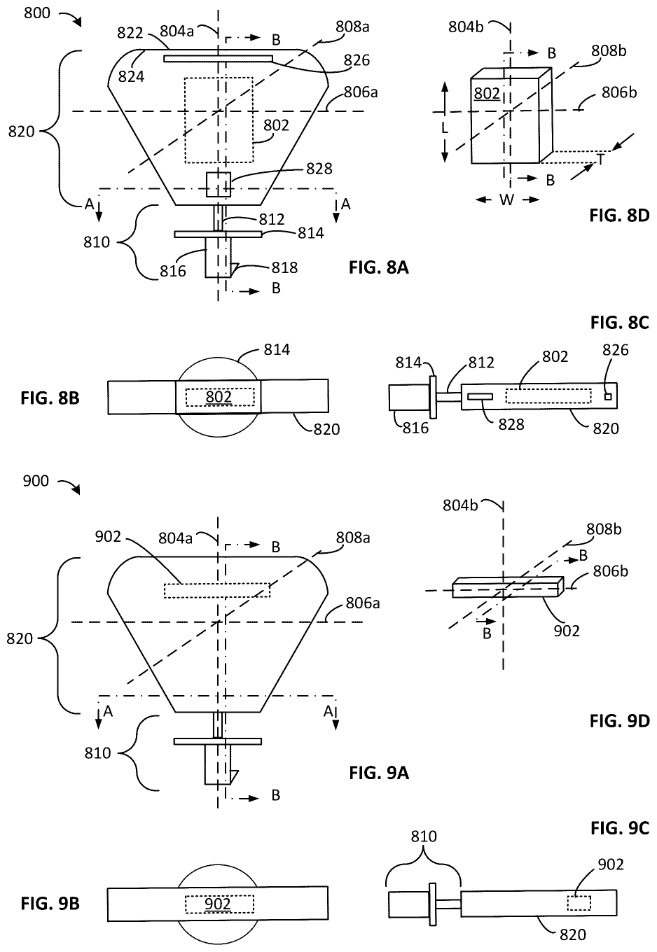

FIGS. 8A-8C depict different views of a head assembly 800 having a battery pack 802. Specifically, FIG. 8A is a side view of the head assembly 800, FIG. 8B is a partial cross-sectional view of a cross-section in the direction “A-A,” and FIG. 8C is a cross-sectional view of a cross-section in the direction “B-B.” FIG. 8D is a perspective view of the battery pack 802. Three axes, 804a, 806a, 808a, are associated with the head assembly 800, where the reciprocating movement/motion of the head assembly 800 occurs along the axis 804a (also referred to as the reciprocating motion axis 804a). The axes 806a, 808a are normal to each other and to the reciprocating motion axis 804a.

The head assembly 800 includes a stem 810 having an upper portion 812, a stopper disc 814, a lower portion 816, and a tab 818. The upper and lower portions 812, 816 can be cylindrical, elliptical, or prism-shaped, where a cross-section of the prism can be triangular, square, rectangular, hexagonal, or in the shape of another polygon. The shapes of the upper and lower portions 812, 816 can be the same or they can be different. In the head assembly 800, the respective sizes (the respective lengths and respective diameters), of the upper and lower portions 812, 816 are different. In other embodiments, one or more of these respective dimensions, including the respective cross-sectional dimensions of prism-shaped upper and/or lower portions of the stem, can be the same. In general, the dimensions of the stem 810 are such that the battery pack 802 cannot fit within the stem 810. The stem 810 and/or portions thereof can be hollow or solid.

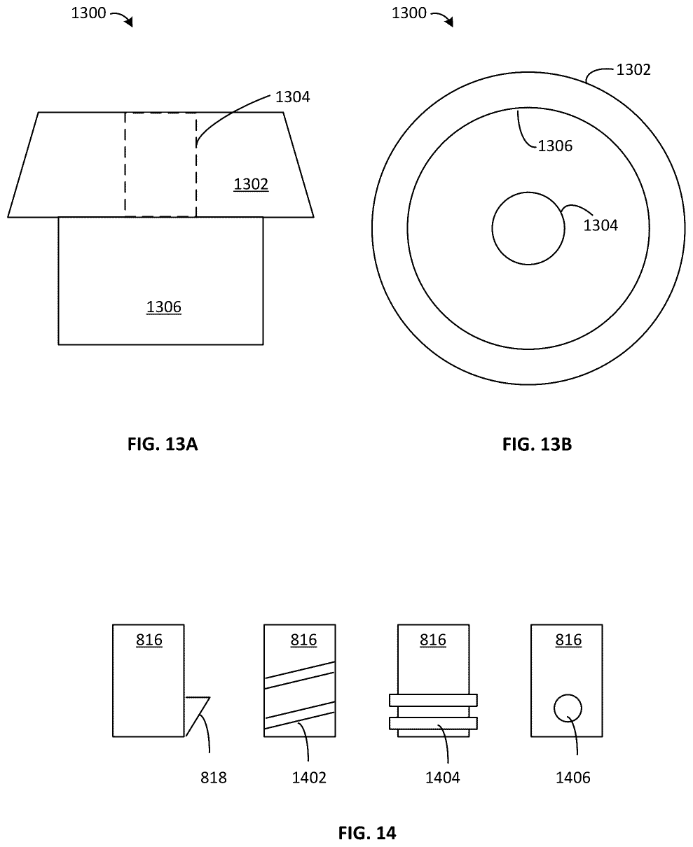

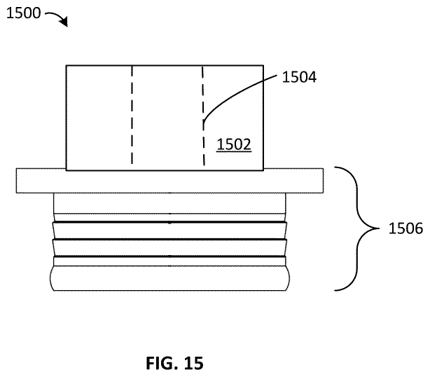

The dimensions of the lower portion 816 are chosen such that it can fit tightly into a cavity (also referred to as a bore) within a coupler (see FIGS. 13A, 13B, and 15), where the coupler is adapted to engage with a piston of a therapeutic device. Thus, the length and diameter(s) (or other cross-sectional dimension(s)) of the lower portion 816 are selected to match with the corresponding dimensions of the cavity/bore (see 13A, 13B, and 15) within the coupler, where the lower portion 816 is received within the cavity. The stopper disc 814 can guide how far the lower portion 816 may be pushed into the cavity. In some embodiments, the stopper disc 814 is omitted. In such an embodiment, the upper and lower portions 812, 816 may be formed as a single continuous portion.

The head assembly 800 may be aligned with the cavity such that the tab 818 is received within a corresponding notch within the cavity. Upon inserting into the cavity, the head assembly 800 may be twisted such that the tab 818 disengages from the corresponding notch, and slides with a groover within the cavity, and as such, cannot be separated from the coupler until the head assembly is twisted back, to align the tab 818 with the corresponding notch in the cavity. Thus, the tab 818, together with the corresponding notch in the cavity of coupler, functions as a locking mechanism for the head assembly 800. In some embodiments, more than one tabs, e.g., two or four tabs and corresponding notches in the cavity of the coupler may be provided. Locking mechanisms other than tabs and notches may also be provided in different embodiments, as discussed below with reference to FIG. 14.

The head assembly 800 also includes a head portion 820, that contains the battery pack 802. The battery pack may include a battery, such as that described with reference to FIG. 3, and an optional box or encasing for the battery. As described above, a battery (or a battery pack) having a flat profile with respect to one of its axes may be referred to as a low profile battery/battery pack. As seen in FIG. 8D, the battery pack 802 has a flat profile with respect to the axis 808b of the battery pack 802 because each of the dimensions (e.g., length (L) and width (W)) of the battery pack 802 along the axes 804b, 806b, respectively, of the battery pack 802 is at least two times the dimension (thickness “T”) of the battery pack 802 along the axis 808b. Because the battery pack 802 has a flat profile with respect to the axis 808b, it is a low-profile battery pack. The head portion 820 is designed such that the battery pack 802 can be contained within the head portion 820. The axes 804b, 806b, 808b of the battery pack may be aligned with or may coincide with the axes 804a, 806a, 808a, respectively, of the head assembly 800.

The head portion 820 has an outer surface 822 and an inner surface 824. The outer surface 822 may contact a region of a body where therapeutic treatment (e.g., percussive massage, heat, or a combination of heat and percussive massage) is to be applied. Furthermore, the head portion 820 includes a heating element 826 and a circuit board/controller 828. While the heating element 826 is planar, in some embodiments, the heating element 826 can have one or more curved surfaces, as discussed above. As discussed above with reference to FIG. 4A, the heating element 826 is designed not to span the entire inner surface 824 of the head portion 820. In other embodiments, the heating element 826 may span the entire inner surface 824 of the head portion 820.

The heating element 826 is electrically coupled to the battery pack 802 and the controller 828. The controller 828 may be operated in a manner similar to the operation of the circuit board 316 (FIG. 3), so as to provide a heat treatment by itself or in combination with percussive massage treatment, as described above. The head portion 820 may also include foam layers (similar to the foam layers 314a, 314b (FIG. 3)) above and below the battery pack 802. In some embodiments, a clamp (similar to the clamp 318 (FIG. 3)), together with or without a foam layer (e.g., the cover foam layer 408 (FIG. 4C)), is provided between the heating element 826 and the battery pack 802.

FIGS. 9A-9C depict different views of another head assembly 900 having a battery pack 902. Specifically, FIG. 9A is a side view of the head assembly 900, FIG. 9B is a partial cross-sectional view of a cross-section in the direction “A-A,” and FIG. 9C is a cross-sectional view of a cross-section in the direction “B-B.” FIG. 9D is a perspective view of the battery pack 902. The head assembly 900 is similar to the head assembly 800 (FIGS. 8A-8C), except that the battery pack 902 is somewhat different from the battery pack 802. In particular, the battery pack 802 has a flat profile along only the axis 808b thereof, which is normal to the axis 804b that may align or coincide with the reciprocating motion axis 804a. The battery pack 802 has an elongated profile along the axes 804b and 806b. In contrast, the battery pack 902 has a flat profile along the axis 804b, which may align or coincide with the reciprocating motion axis 804a, and also along the axis 808b, which is normal to the axis 804b. The battery pack 902 has an elongated profile along the axis 806b thereof, which is normal to both the axes 804b and 808b.

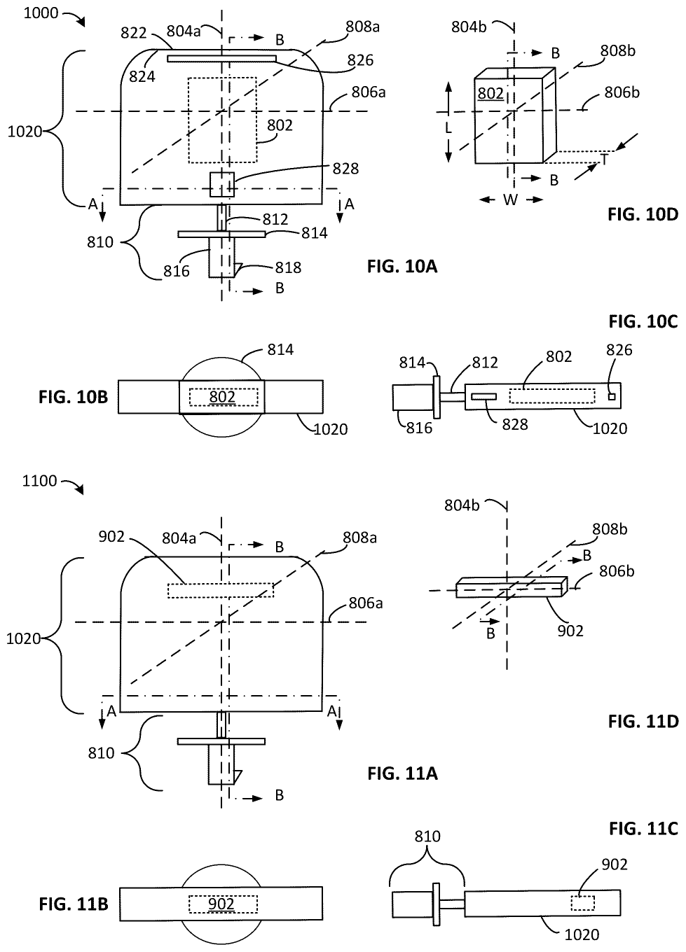

FIGS. 10A-10C depict different views of yet another head assembly 1000 having the battery pack 802 of the head assembly 800 (FIG. 8A). Specifically, FIG. 10A is a side view of the head assembly 1000, FIG. 10B is a partial cross-sectional view of a cross-section in the direction “A-A,” and FIG. 10C is a cross-sectional view of a cross-section in the direction “B-B.” FIG. 10D is a perspective view of the battery pack 802. Referring to FIG. 8A, the shape of the head portion 820 of the head assembly 800 is partially conical. In contrast, referring to FIG. 10A, the head portion 1020 of the head assembly 1000 is partially box or brick shaped or cuboidal. Otherwise, the head assemblies 800 and 1000 are generally similar.

FIGS. 11A-11C depict different views of a head assembly 1100 having the battery pack 902 of the head assembly 900 (FIG. 9A). Here again, FIG. 11A is a side view of the head assembly 1100, FIG. 11B is a partial cross-sectional view of a cross-section in the direction “A-A,” and FIG. 11C is a cross-sectional view of a cross-section in the direction “B-B.” FIG. 11D is a perspective view of the battery pack 902. Thus, the head assembly 1100 includes the partially box or brick shaped or cuboidal head portion 1020 of the head assembly 1000 (FIG. 10A), and the battery pack 902 that has a flat profile along two axes, namely, the axis 804b, which may align or coincide with the reciprocating motion axis 804a, and the axis 808b, which is normal to the axis 804b. As noted above, the battery pack 902 has an elongated profile along the axis 806b, which is normal to both the axes 804b and 808b.

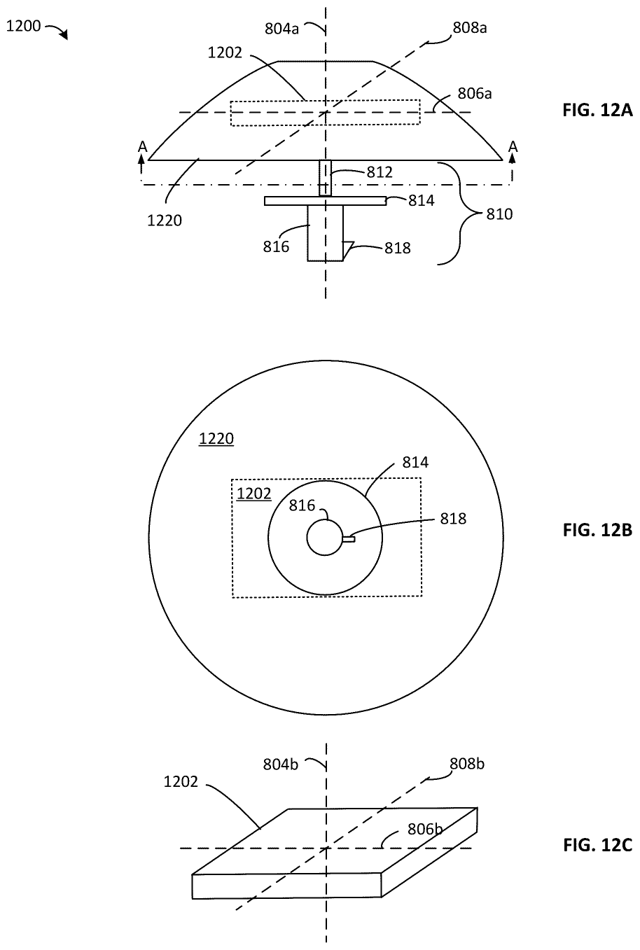

FIGS. 12A and 12B depict side and bottom cross-sectional views (in the direction “A-A”) of a head assembly 1200 having the battery pack 1202. The head portion 1220 of the head assembly 1200 is mushroom-shaped. As seen in FIG. 12C, the battery pack 1202 has a flat profile along the axis 804b, which may align or coincide with the reciprocating motion axis 804a. Along the other two axes 806b, 808b thereof, the battery pack 1202 has an elongated profile. Each of the head assemblies 900, 1000, 1100, and 1200 includes a respective heating element and a respective controller for controlling the heating element. These components are not shown in the FIGS. 9A-9C, 10A-10C, 11A-11C, 12A, and 12B only for simplicity and clarity.

A head assembly (such as those shown in FIGS. 8A, 9A, 10A, 11A, and 12A) is designed to fit removably within the main body a therapeutic device, such as that shown in FIG. 1. Moreover, the head assembly is designed to engage with a piston within the main body of the therapeutic device. As such, in operation, the reciprocating motion of the piston can be translated into a reciprocating motion of the head assembly, which can impart a percussive massage to a region of the body in contact with the head assembly. Additionally, it is desirable that different head assemblies, e.g., those having different shapes and/or sizes, can be removably coupled to the main bodies of different therapeutic devices, where such main bodies and pistons therein can have different shapes and/or sizes, and/or operational parameters such as impact force, frequency of reciprocating motion, etc. To allow for such flexibility, a coupler, e.g., the coupler 1300 shown in FIGS. 13A and 13B is provided in various embodiments.

The coupler 1300 has an upper section 1302 having a cavity (also referred to as a bore) 1304 and a lower section 1306. The size and shape of the lower section 1306 are selected such that they match (within an allowable tolerance) the size and shape of a piston in the main body of a therapeutic device. Typically, the lower section 1306 may be received within a cavity in the piston, as discussed above referring to FIGS. 7A-7D. The size and shape of the bore 1304 in the upper section 1302 are selected to match (within an allowable tolerance) the size and shape of the lower portion 816 of the stem 810 of the head assembly. Here again, typically, the lower portion 816 is received within the bore 1304.

In order to avoid an unintentional disengagement between the head assembly (e.g., the head assembly 800) and the coupler 1300, the lower portion 816 of the stem 810 includes a locking mechanism, and the bore 1304 of the coupler 1300 includes a corresponding mating locking mechanism. For example, as discussed above referring to FIGS. 8A and 8B, an overall locking mechanism may include a tab 818 protruding from the lower portion 816 of the stem 810, and a notch within the bore 1304 of the coupler 1300. As shown in FIG. 14, a locking mechanism may include a threading 1402, or one or more rings 1404, and/or one or more magnets 1406, on the lower portion 816 of the stem 810. The bore 1304 (FIG. 13) may include a corresponding threaded groove, one or more grooves matching the rings 1404, and/or one or more magnets having opposite polarities of the magnets 1406. In different embodiments, two or more of the locking mechanisms may be combined.

FIG. 15 depicts a coupler 1500 having a cylindrical upper portion 1502 having a bore 1504. The lower portion 1506 of the coupler 1500 is similar to the stem portion 700 (FIGS. 7A-7D) having a barbed surface, so that that the lower portion 1506 of the coupler 1500 can fit tightly but removably within a cavity of a piston in the main body of a therapeutic device. Because the bore of a coupler can be designed to match and mate with the lower portion of the stem of a particular head assembly, and because the lower portion of the coupler can be designed to match and mate with the piston within the main body of a particular therapeutic deice, a suitable coupler can be designed and/or selected to allow for fitting and locking many different types of head assemblies within the main bodies of many different types of therapeutic devices.

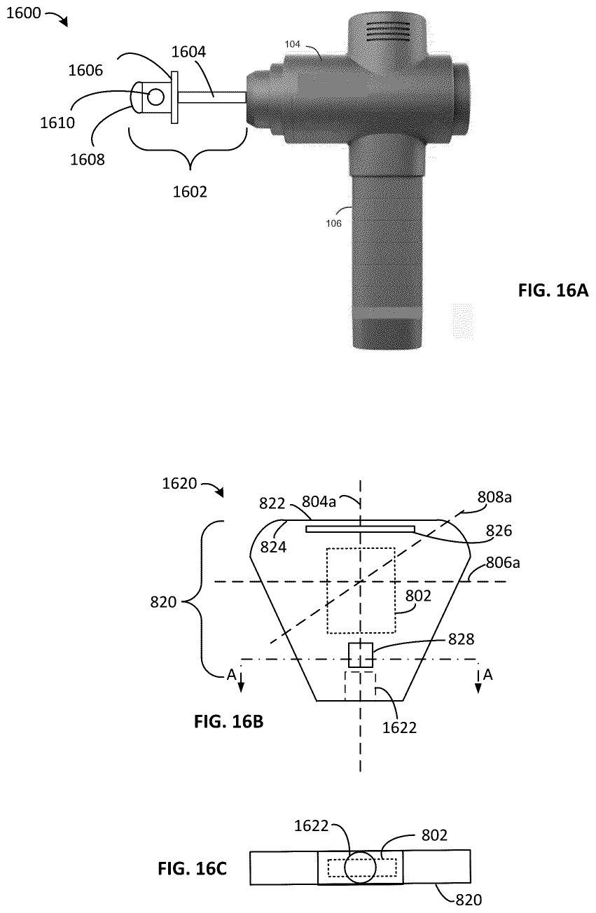

FIGS. 16A-16C depict an embodiment of a percussive massage applicator 1600. Like the massage applicator 100 (FIG. 1), the massage applicator 1600 (FIG. 16A) has a main body 104, and a handle 106. Unlike the massage applicator 100 (FIG. 1), however, the massage applicator 1600 (FIG. 16A) includes a stem 1602 that is non-removably attached to the main body 104. The stem 1602 engages with a piston within the main body 104, and moves back and forth, when the massage applicator 1600 is operated. When a massage applicator head is attached to the stem 1602, during operation of the massage applicator 1600, the head would also move back and forth. During operation, when the massage applicator 1600 is positioned such that the head is in contact with or proximate a body part, the back-and-forth motion of the head would apply percussive of tapping forces to the body part. The head can also apply her to the body part as discussed above and below.

The stem 1602 includes a rod 1604, a stopper disc 1606, and a head-engagement part 1608. The stopper disc 1606 is optional, and is not provided in some embodiments. The rod 1604 is typically cylindrical having a circular cross-section, but can have an elliptical cross-section. In some embodiments, the rod can be prism-shaped, having a triangular, square, or other polygonal cross-section. The head-engagement part 1608 in some embodiments may have substantially the same cross-sectional dimensions as those of the rod 1604. The head-engagement part 1608 also includes a locking mechanism 1610, that is discussed further below.

Referring to FIGS. 16B and 16C, the massage applicator 1600 includes a massage applicator head 1620 that is similar to the head portion 820 of the head assembly 800 (FIG. 8A). The head 1620 can be removably affixed to the stem 1602 (FIG. 16A), where the stem 1602 is non-removably attached to the main body 104 of the massage applicator 1600. FIGS. 16B and 16C are the side view and partial bottom view (in the direction “A-A”) of the head 1620, respectively. Like the head portion 820 (FIG. 8A), the head 1620 (FIGS. 16B and 16C) includes a flat-profile battery/battery pack 802, a heating element 826, and a circuit board/controller 828 (FIG. 8A). Unlike the head assembly 800 (FIG. 8A), the head 1620 (FIGS. 16B and 16C), does not include a stem. Instead, the head 1620 includes a bore or a recess 1622 that is designed to receive and fit therewithin the head-engagement part 1608 of the stem 1602 (FIG. 16A). To this end, the shape and size of the cross-section of the bore/recess 1622 are substantially the same as, respectively, those of the head-engagement part 1608. The stopper disc 1606 can prevent the over insertion of the head-engagement part 1608 into the head 1620.

The locking mechanism 1610 (FIG. 16A) includes a set of magnets (only one is shown), similar to the magnets 1406 (FIG. 14). The locking mechanism of the head-engagement part 1608 of the stem 1602 (FIG. 16A) may alternatively or additionally include one or more other locking mechanisms, such as a threading 1402 or one or more rings 1404 (FIG. 14). In some embodiments, the locking mechanism of the head-engagement part 1608 (FIG. 16A) may include a tab, similar to the tab 818 of the lower portion 816 of the stem 810 (FIG. 8A).

A head that can be removably attached to the stem 1602 can be similar to: (i) the head portion 820 depicted in and described above with reference to FIGS. 9A-9D; or (ii) the head portions 1020 depicted in and described above with reference to FIGS. 10A-11D; or (iii) the head portion 1220 depicted in and described above with reference to FIGS. 12A-12C. In each case, however, the head would include a bore that is designed to receive and fit therewithin the head-engagement part 1608 (FIG. 16A). To this end, the shape and size of the cross-section of the bores are designed to be substantially the same as, respectively, those of the head-engagement part 1608.

One purpose of the locking mechanism of the head-engagement part 1608 (FIG. 16A) is to avoid an unintentional disengagement of the head 1620 (FIG. 16B) from the stem 1602 (FIG. 16A) that is non-removably attached to the main body 104 of the massage applicator 1600. Therefore, the bore/recess 1622 (FIGS. 16B, 16C) includes a mating locking mechanism corresponding to that of the head-engagement part 1608 (FIG. 16A). For example, as discussed above referring to FIGS. 8A and 8B, an overall locking mechanism may include a tab protruding from the head-engagement part 1608 of the stem 1602 (FIG. 16A), and a notch within the bore/recess 1622 of the head 1620 (FIG. 16B). The locking mechanism of the head-engagement part 1608 (FIG. 16A) may be referred to as a principal locking mechanism. If the principal locking mechanism includes a threading (e.g., the threading 1402, FIG. 14), or one or more rings (e.g., rings 1404, FIG. 14), and/or one or more magnets (FIG. 16A), the bore/recess 1622 (FIG. 16B) may include, as the corresponding mating locking mechanism, a threaded groove, one or more grooves matching the rings, and/or one or more magnets having opposite polarities of the magnets. In different embodiments, two or more of the locking mechanisms may be combined.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the subject matter have been described. Other embodiments are within the scope of the following claims. Accordingly, other implementations are within the scope of the following claims. The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

As various changes could be made in the above constructions without departing from the scope of the invention, it is intended that all the matter contained in the above description or shown in the accompanying drawings shall be interpreted as illustrative and not in a limiting sense.

What is claimed is:

1. A head assembly for a therapeutic device, the head assembly comprising:
a stem portion, devoid of a battery pack; and
a head portion comprising a flat-profile mounted battery pack.

2. The head assembly of claim 1, wherein the stem portion is solid.

3. The head assembly of claim 1, wherein the flat-profile mounted battery pack comprises a lithium-polymer battery.

4. The head assembly of claim 1, wherein the flat-profile mounted battery pack has a rectangular top surface.

5. The head assembly of claim 1, wherein the head portion further comprises:
a top foam layer and a bottom foam layer, wherein the flat-profile mounted battery pack is disposed between the top and bottom foam layers.

6. The head assembly of claim 1, wherein the head portion further comprises:
a cover having inner and outer surfaces; and
a heating element: (i) electrically coupled to the flat-profile mounted battery pack, and (ii) defining a bounding box, wherein an area of the bounding box is smaller than an area of the inner surface of the cover.

7. The head assembly of claim 6, wherein the head portion further comprises:
a circuit board that is electrically coupled to the heating element and the flat-profile mounted battery pack, for controlling heating of the heating element.

8. The head assembly of claim 7, wherein the head portion further comprises:
a clamp for holding together the flat-profile mounted battery pack and the circuit board.

9. The head assembly of claim 8, wherein the head portion further comprises:
a cover foam layer disposed between the heating element and the clamp.

10. The head assembly of claim 1, wherein the stem portion comprises:
a first tapering friction ring having a top side facing the head portion and an opposing bottom side, wherein a first maximum diameter of the first tapering friction ring at the top side thereof is greater than the first smallest diameter of the first tapering friction ring at the bottom side thereof,
wherein a diameter of an inner section of the stem portion is smaller than an inner diameter of a receiver portion of the therapeutic device, wherein the receiver portion is configured to removably receive the stem portion, and
wherein the first maximum diameter is greater than the inner diameter of the receiver portion.

11. The head assembly of claim 10, wherein the stem portion further comprises:
a second tapering friction ring having a top side facing the head portion and an opposing bottom side, wherein a second maximum diameter of the second tapering friction ring at the top side thereof is greater than a second smallest diameter of the second tapering friction ring at the bottom side thereof.

12. The head assembly of claim 11, wherein:
the second maximum diameter is same as the first maximum diameter; and
the second smallest diameter is same as the first smallest diameter.

13. The head assembly of claim 11, wherein:
the second maximum diameter is smaller than the first maximum diameter.

14. The head assembly of claim 11, wherein:
a thickness of the second tapering friction ring is same as a thickness of the first tapering friction ring.

15. The head assembly of claim 10, wherein the stem portion further comprises:
a fitting ring adapted to match a groove in the receiver portion of the therapeutic device.

16. A head assembly for a therapeutic device, the head assembly comprising:
a head portion comprising a battery pack; and
a stem, devoid of any battery pack, adapted to mate and lock with, via a locking mechanism, a coupler for coupling the head assembly to a body of the therapeutic device.

17. The head assembly of claim 16, wherein the stem is solid.

18. The head assembly of claim 16, wherein the locking mechanism comprises a tab, or a threading, or a ring, or a magnet.

19. The head assembly of claim 16, further comprising:
the coupler, wherein the coupler is adapted to fit within a piston of the therapeutic device.

20. The head assembly of claim 16, wherein the battery pack comprises a lithium-polymer battery.

21. The head assembly of claim 16, wherein:
the head assembly has an axis of reciprocating movement; and
the battery pack has an elongated profile along a first battery axis aligned with the axis of reciprocating movement and a flat profile along a second battery axis normal to the axis of reciprocating movement.

22. The head assembly of claim 16, wherein:
the head assembly has an axis of reciprocating movement; and
the battery pack has a flat profile along a first battery axis aligned with the axis of reciprocating movement.

23. The head assembly of claim 16, wherein the head portion further comprises:
a cover having inner and outer surfaces; and
a heating element: (i) electrically coupled to the battery pack, and (ii) disposed between the inner surface of the cover and the battery pack.

24. The head assembly of claim 23, wherein the heating element defines a bounding box, wherein an area of the bounding box is smaller than an area of the inner surface of the cover.

25. The head assembly of claim 23, wherein the head portion further comprises:
a circuit board that is electrically coupled to the heating element and the battery pack, for controlling heating of the heating element.

26. A massage applicator head for a therapeutic device, the massage applicator head lacking a stem, and comprising:
a battery pack; and
a bore adapted to receive a head-engagement part of a stem attached to a body of the therapeutic device, the bore comprising a mating locking mechanism corresponding to a principal locking mechanism of the head-engagement part.

27. The massage applicator head of claim 26, wherein:
the principal locking mechanism comprises a tab, or a threading, or a ring, or a magnet; and
the mating locking mechanism comprises a notch, a groove, or a magnet.

28. The massage applicator head of claim 26, wherein the battery pack comprises a lithium-polymer battery.

29. The massage applicator head of claim 26, wherein:
the massage applicator head has an axis of reciprocating movement; and
the battery pack has an elongated profile along a first battery axis aligned with the axis of reciprocating movement and a flat profile along a second battery axis normal to the axis of reciprocating movement.

30. The massage applicator head of claim 26, wherein:
the massage applicator head has an axis of reciprocating movement; and
the battery pack has a flat profile along a first battery axis aligned with the axis of reciprocating movement.

31. The massage applicator head of claim 26, further comprising:
a cover having inner and outer surfaces; and
a heating element: (i) electrically coupled to the battery pack, and (ii) disposed between the inner surface of the cover and the battery pack.

32. The massage applicator head of claim 31, wherein the heating element defines a bounding box, wherein an area of the bounding box is smaller than an area of the inner surface of the cover.

33. The massage applicator head of claim 31, further comprising:
a circuit board that is electrically coupled to the heating element and the battery pack, for controlling heating of the heating element.
